(19) United States
(12) Patent Application Publication
(10) Pub. No.: US 2026/0300713 A1
(43) Pub. Date: Oct. 1, 2026

(54) CONSORTIUM MODEL TRAINING AND INFERENCE USING CLIENT-DEFINED PRIVACY-PRESERVING FEATURE TRANSFORMATIONS

(71) Applicant: Fair Isaac Corporation, Minneapolis, MN (US)

(72) Inventors: Scott Michael Zoldi, San Diego, CA (US); Amir-Salar Esteki, San Diego, CA (US)

(21) Appl. No.: 19/093,661

(22) Filed: Mar. 28, 2025

(51) Int. Cl. G06N 3/08; H04L 9/32

(52) U.S. Cl. CPC G06N 3/08; H04L 9/3236

(57) ABSTRACT

A computer-implemented method, comprising obtaining a transformed dataset from a data owner, the transformed dataset comprising a plurality of transformed values derived from a list of transformed summarized features, wherein the transformed dataset is associated with an entity and is devoid of interpretable or reconstructable data regarding the entity; generating a target-related measure based on a target label associated with the transformed dataset, wherein the target-related measure comprises a numerical value that reflects a statistical relationship between a range of the transformed values and associated target label; generating an input feature vector, for the entity, wherein the input feature vector comprises the target-related measures corresponding to the list of transformed summarized features; and training a neural network classifier using a plurality of input feature vectors generated from multiple transformed datasets respectively obtained from a plurality of data owners.

### TECHNICAL FIELD

The subject matter described herein relates to machine learning-based model development systems, specifically systems and methods for training and deploying consortium models using transformed feature representations.

### BACKGROUND

Machine learning systems are increasingly deployed across industries such as healthcare, financial services, and cybersecurity to perform predictive tasks involving sensitive and distributed data. In many of these domains, organizations operate independently and are bound by regulatory, privacy, or competitive constraints that prohibit the direct sharing of raw data. Nevertheless, there is a growing need to build models that benefit from broader, cross-organizational patterns which can enhance performance through data diversity and scale.

Collaborative modeling, such as consortium-based machine learning, presents an opportunity to leverage information from multiple data owners without centralizing data. However, these efforts face significant challenges. Chief among them is the inability to reconcile data privacy with model quality. Direct sharing of raw features, even if anonymized, may still pose unacceptable risks in regulated or privacy-sensitive domains. Additionally, when data owners apply differing preprocessing standards or privacy controls, it becomes difficult to align data representations in a manner that supports unified model training.

Moreover, conventional privacy-preserving techniques-such as differential privacy, secure multiparty computation, or homomorphic encryption-often introduce computational or integration burdens that limit practical adoption in production environments. In many cases, these methods are incompatible with the heterogeneous systems and security policies across participating entities. Additionally, many data owners require that data not cross institutional or geographic boundaries, and that any collaborative processing comply with applicable legal and regulatory requirements. Furthermore, existing privacy-preserving methods often lead to a trade-off between model performance and privacy protection. While these techniques provide strong guarantees of data confidentiality, they may degrade predictive accuracy due to noise injection, cryptographic overhead, or misaligned feature representations Therefore, there exists a need for an approach that enables privacy-conscious entities to contribute to collaborative model training and inference without exposing sensitive or reconstructable information, and without imposing excessive implementation complexity.

### SUMMARY

Methods, systems, and articles of manufacture, including computer program products, are provided for generating a consortium model. In one aspect, there is provided a method, including: obtaining a transformed dataset from a data owner, the transformed dataset comprising a plurality of transformed values derived from a list of transformed summarized features, wherein the transformed dataset is associated with an entity and is devoid of interpretable or reconstructable data regarding the entity; generating a target-related measure based on a target label associated with the transformed dataset, wherein the target-related measure comprises a numerical value that reflects a statistical relationship between a range of the transformed values and associated target label; generating an input feature vector, for the entity, wherein the input feature vector comprises the target-related measures corresponding to the list of transformed summarized features; and training a neural network classifier using a plurality of input feature vectors generated from multiple transformed datasets respectively obtained from a plurality of data owners, wherein the plurality of input feature vectors comprises the input feature vector.

In some variations, the transformed dataset is generated by extracting a plurality of summarized features from a raw dataset using methods that are transparent to the data owners and executed within systems controlled by the data owners; calculating values associated with the plurality of summarized features; and hashing the values of the plurality of summarized features using a monotonically increasing hash function that preserves order of the values to generate the plurality of transformed values for the transformed dataset, wherein the hash function is data owner-defined and private to the data owner.

In some variations, the method further comprising converting the plurality of transformed values into a plurality of intervals based on a statistical distribution of the transformed values by applying a converting scheme to the transformed values, wherein the converting scheme is data owner-specific, wherein each of the plurality of intervals corresponds to a range of the transformed values in the plurality of the transformed values.

In some variations, generating the target-related measure comprises computing, for each interval, a frequency-based statistic representing co-occurrence of target labels within the interval.

In some variations, the target-related measure comprises a weight of evidence value calculated for each interval based on relative proportions of positive and negative target labels.

In some variations, the input feature vector comprises a plurality of target-related measures corresponding to different summarized features within the transformed dataset.

In some variations, the method further includes receiving, from a first data owner, an inferencing transformed dataset comprising a plurality of transformed values derived from summarized features associated with a second entity, the inferencing transformed dataset being devoid of interpretable or reconstructable data; retrieving, for the second entity, a secondary target-related measure computed for the first data owner during training for the second entity; generating an input feature vector comprising the retrieved target-related measures; and providing the input feature vector to the trained neural network classifier to generate an output for the entity.

In another aspect, there is provided a system comprising: a programmable processor; and a non-transient machine-readable medium storing instructions that, when executed by the processor, cause the at least one programmable processor to perform operations. The operations include obtaining a transformed dataset from a data owner, the transformed dataset comprising a plurality of transformed values derived from a list of transformed summarized features, wherein the transformed dataset is associated with an entity and is devoid of interpretable or reconstructable data regarding the entity; generating a target-related measure based on a target label associated with the transformed dataset, wherein the target-related measure comprises a numerical value that reflects a statistical relationship between a range of the transformed values and associated target label; generating an input feature vector, for the entity, wherein the input feature vector comprises the target-related measures corresponding to the list of transformed summarized features; and training a neural network classifier using a plurality of input feature vectors generated from multiple transformed datasets respectively obtained from a plurality of data owners, wherein the plurality of input feature vectors comprises the input feature vector.

In some variations, the transformed dataset is generated by extracting a plurality of summarized features from a raw dataset using methods that are transparent to the data owners and executed within systems controlled by the data owners; calculating values associated with the plurality of summarized features; and hashing the values of the plurality of summarized features using a monotonically increasing hash function that preserves order of the values to generate the plurality of transformed values for the transformed dataset, wherein the hash function is data owner-defined and private to the data owner.

In some variations, the operations further include converting the plurality of transformed values into a plurality of intervals based on a statistical distribution of the transformed values by applying a converting scheme to the transformed values, wherein the converting scheme is data owner-specific, wherein each of the plurality of intervals corresponds to a range of the transformed values in the plurality of the transformed values.

In some variations, generating the target-related measure comprises computing, for each interval, a frequency-based statistic representing co-occurrence of target labels within the interval.

In some variations, the target-related measure comprises a weight of evidence value calculated for each interval based on relative proportions of positive and negative target labels.

In some variations, the input feature vector comprises a plurality of target-related measures corresponding to different summarized features within the transformed dataset. In some variations, the operations further include receiving, from a first data owner, an inferencing transformed dataset comprising a plurality of transformed values derived from summarized features associated with a second entity, the inferencing transformed dataset being devoid of interpretable or reconstructable data; retrieving, for the second entity, a secondary target-related measure computed for the first data owner during training for the second entity; generating an input feature vector comprising the retrieved target-related measures; and providing the input feature vector to the trained neural network classifier to generate an output for the entity.

In another aspect, there is provided a computer program product including a non-transitory computer readable medium storing instructions that, when executed by at least one programmable processor, cause the at least one programmable processor to perform operations. The operations include obtaining a transformed dataset from a data owner, the transformed dataset comprising a plurality of transformed values derived from a list of transformed summarized features, wherein the transformed dataset is associated with an entity and is devoid of interpretable or reconstructable data regarding the entity; generating a target-related measure based on a target label associated with the transformed dataset, wherein the target-related measure comprises a numerical value that reflects a statistical relationship between a range of the transformed values and associated target label; generating an input feature vector, for the entity, wherein the input feature vector comprises the target-related measures corresponding to the list of transformed summarized features; and training a neural network classifier using a plurality of input feature vectors generated from multiple transformed datasets respectively obtained from a plurality of data owners, wherein the plurality of input feature vectors comprises the input feature vector.

In some variations, the transformed dataset is generated by extracting a plurality of summarized features from a raw dataset using methods that are transparent to the data owners and executed within systems controlled by the data owners; calculating values associated with the plurality of summarized features; and hashing the values of the plurality of summarized features using a monotonically increasing hash function that preserves order of the values to generate the plurality of transformed values for the transformed dataset, wherein the hash function is data owner-defined and private to the data owner.

In some variations, the operations further include converting the plurality of transformed values into a plurality of intervals based on a statistical distribution of the transformed values by applying a converting scheme to the transformed values, wherein the converting scheme is data owner-specific, wherein each of the plurality of intervals corresponds to a range of the transformed values in the plurality of the transformed values.

In some variations, generating the target-related measure comprises computing, for each interval, a frequency-based statistic representing co-occurrence of target labels within the interval.

In some variations, the target-related measure comprises a weight of evidence value calculated for each interval based on relative proportions of positive and negative target labels.

In some variations, the input feature vector comprises a plurality of target-related measures corresponding to different summarized features within the transformed dataset. In some variations, the operations further include receiving, from a first data owner, an inferencing transformed dataset comprising a plurality of transformed values derived from summarized features associated with a second entity, the inferencing transformed dataset being devoid of interpretable or reconstructable data; retrieving, for the second entity, a secondary target-related measure computed for the first data owner during training for the second entity; generating an input feature vector comprising the retrieved target-related measures; and providing the input feature vector to the trained neural network classifier to generate an output for the entity.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an exemplary system 100 for privacy-preserving training and inference of a machine learning model, such as a neural network, using transformed data representations, in accordance with one or more embodiments of the current subject matter.

FIG. 2 is a diagram illustrating an exemplary component of system that supports the local generation of open features at the client side, in accordance with one or more embodiments of the current subject matter.

FIG. 3 is a diagram illustrating an exemplary transformation process 300 in which a set of open feature values is converted into hashed feature values using client-defined, privacy-preserving hash functions, in accordance with one or more embodiments of the current subject matter.

FIG. 4 is a diagram illustrating an example 400 of how different transformation functions applied to the same original feature distribution may result in diverging value distributions across clients, in accordance with one or more embodiments of the current subject matter.

FIG. 5 is a diagram illustrating a flow chart of a process 500 for training a neural network classifier using privacy-preserving, client-transformed data, in accordance with one or more embodiments of the current subject matter.

FIG. 6 illustrates an example inference process that converts transformed feature values from a client into PTM values, which are subsequently used as input to a pre-trained neural network, in accordance with one or more embodiments of the current subject matter.

FIG. 7 is a diagram illustrating an example process 700 for performing inference on new, transformed datasets obtained from a data owner, where the transformed dataset contains hashed feature values derived from summarized features associated with an entity.

FIG. 8A illustrates the ROC curve comparison between the Original Model and the Single-Client Model, in accordance with one or more embodiments of the current subject matter.

FIG. 8B illustrates the ROC curve comparison between the Original Model and the Two-Client Model, in accordance with one or more embodiments of the current subject matter.

FIG. 9 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

As discussed above, there is a need for a framework that enables collaborative model development while maintaining the privacy of individual datasets across participating entities. The approach described herein facilitates privacy-preserving training and inference by allowing data owners to contribute transformed data representations without exposing sensitive or reconstructable information.

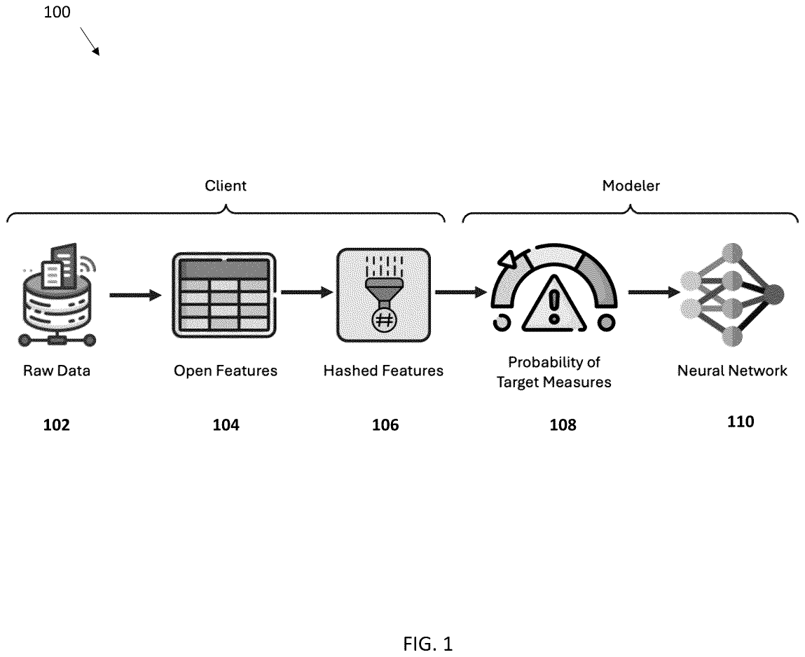

FIG. 1 is a diagram illustrating an exemplary system 100 for privacy-preserving training and inference of a machine learning model, such as a neural network, using transformed data representations, in accordance with one or more embodiments of the current subject matter. As shown in FIG. 1, the system is organized into two logical components: a client side, operated by a data owner, and a modeler side, operated by a party responsible for training and deploying the machine learning model.

As shown in FIG. 1, the client begins with raw data 102, which may include sensitive or regulated information associated with an entity, such as a patient. In some embodiments, the raw data 102 includes structured inputs such as electronic health records or time-series clinical measurements. The client generates open features 104 from the raw data using deterministic and transparent transformation methods. These open features 104 may include summarized feature values such as average heart rate, recent systolic pressure range, or temperature variability. In some embodiments, the feature generation is auditable and executed entirely within systems under the control of the data owner.

As further shown in FIG. 1, the open features 104 are then transformed into hashed features 106 using one or more client-defined hash functions. The hash function may be private to the data owner. The hashed features 106 are designed to be uninterpretable and non-reconstructable by the modeler, thereby protecting sensitive information while enabling downstream statistical use. The transformation may involve mapping each open feature value into a privacy-preserving representation that obscures exact feature values but retains value alignment through hashing.

As shown in FIG. 1, the hashed features 106 are transmitted to the modeler, who applies a pre-established mapping to derive probability of target-related measures 108. In some embodiments, each hashed feature value is associated with a target-related measure-such as a probability score or weight of evidence value—that reflects the statistical relationship between that value (or range) and a known target label, for example, the presence or absence of sepsis of a patient. These measures may be computed using labeled data previously obtained and are specific to the statistical distribution of each hashed feature.

The resulting target-related measures are assembled into an input feature vector, which, as shown in FIG. 1, is provided to a neural network 110. In some embodiments, the neural network is trained on target-related measure vectors generated from multiple clients. During inference, new transformed data from a client can be processed in the same manner to produce a corresponding input vector. As shown in FIG. 1, the system 100 enables collaborative model training and inference without exposing raw feature values or any interpretable or reconstructable information to the modeler.

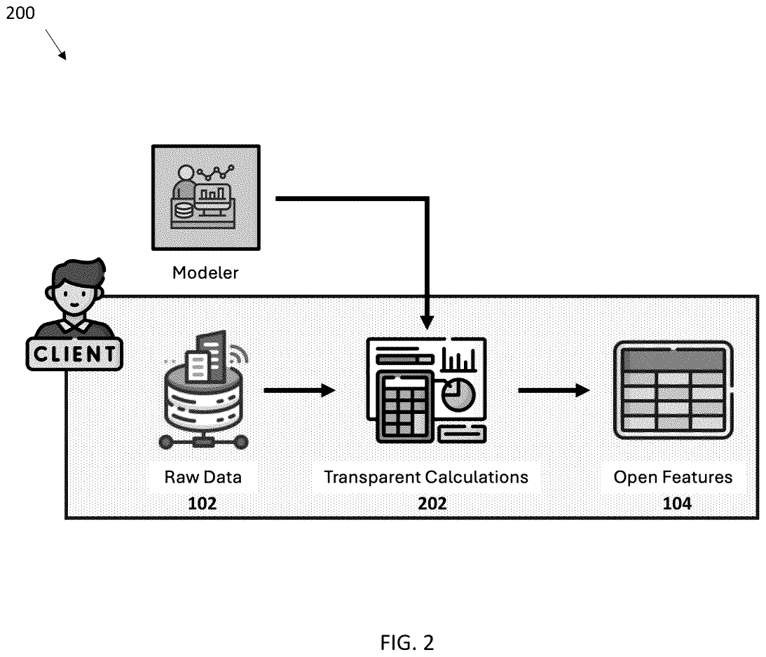

FIG. 2 is a diagram illustrating an exemplary component of system 200 that supports the local generation of open features 104 at the client side, in accordance with one or more embodiments of the current subject matter. As shown in FIG. 2, the operations occur entirely within the client environment, and are initiated using raw data 102, which remains stored and processed locally. In some embodiments, the raw data 102 may include time-series physiological signals, clinical laboratory test results, patient demographics, or other structured healthcare data associated with an entity such as a patient. The raw data may originate from an electronic health record system, bedside monitoring devices, or other medical data sources.

As further shown in FIG. 2, the client performs a set of transformations referred to as transparent calculations 202. These calculations are designed to generate higher-level representations-referred to as open features-without exposing the original data or violating privacy constraints. In some embodiments, transparent calculations may include operations such as computing a moving average of heart rate over a defined window, extracting a maximum value from recent respiratory rates, or generating a variability measure for temperature fluctuations.

The term “transparent” refers to the fact that the transformation logic used to produce open features is known and auditable by the data owner. In some cases, the transformation rules may be provided by the modeler, for example, in the form of a standardized feature definition file or a portable computation module. However, as shown in FIG. 2, the execution of such calculations is confined to the client's local infrastructure and may be implemented using internal analytic pipelines or secure execution environments. This design allows the client to inspect, verify, and control the transformation logic, ensuring that sensitive information is not unintentionally exposed.

The result of these operations is a set of open features 104, which capture summarized statistical properties of the raw data in a format that is structured and consistent across clients, but does not contain directly interpretable sensitive values. The open features 104 may be numerical vectors or tabular representations suitable for further transformation steps such as hashing, as described elsewhere herein. Because the entire process of generating open features takes place within the client system and is based on transparent logic, FIG. 2 illustrates how system 200 may support privacy preservation prior to any data transmission to the modeler.

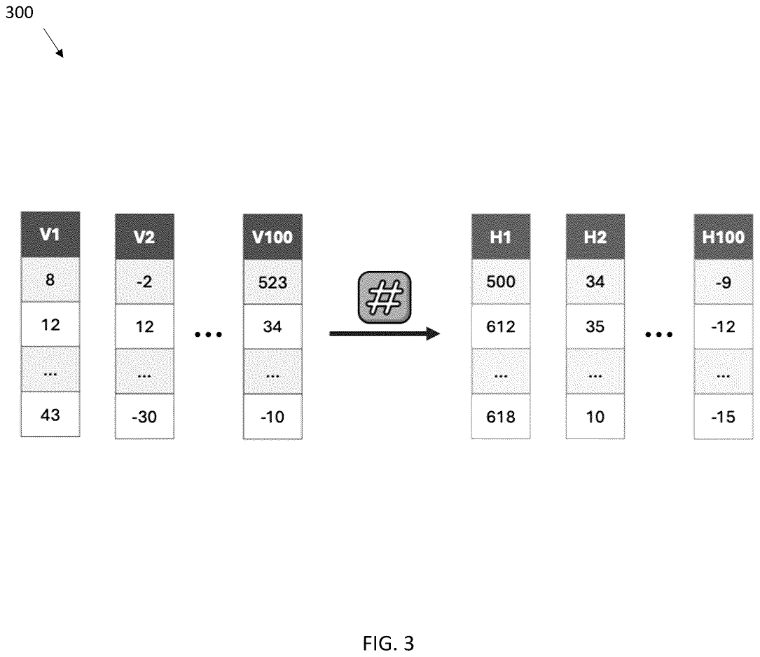

FIG. 3 is a diagram illustrating an exemplary transformation process 300 in which a set of open feature values is converted into hashed feature values using client-defined, privacy-preserving hash functions, in accordance with one or more embodiments of the current subject matter. As shown in FIG. 3, a collection of open feature columns—labeled V1 through V100—represents feature values computed for a plurality of summarized features associated with different entities, such as patients in a sepsis prediction task. Each column corresponds to a different summarized feature, for example, average heart rate (V1), recent systolic blood pressure change (V2), or body temperature variability (V100). Each row within a given column represents the feature value of one entity for that summarized feature. For instance, a row in V1 may hold the average heart rate for one patient over a prior observation window. These feature values, while already summarized, may still be considered sensitive and therefore are not directly shared with the modeler.

To preserve privacy, the client applies a set of hash functions, each corresponding to a particular summarized feature, as shown symbolically at the center of FIG. 3. In some embodiments, these hash functions are strictly monotonically increasing functions that preserve the order of the original feature values while obfuscating their actual values. The hash functions may be implemented using private lookup tables, obfuscated linear mappings, or other deterministic mechanisms. These functions are defined and held privately by the client, and are not transmitted to or shared with the modeler.

The result of this transformation is a new set of feature columns—H1 through H100—shown at the right of FIG. 3. Each hashed feature column contains transformed values that are unintelligible to the modeler but maintain sufficient ordering structure to support subsequent mapping operations, such as the generation of probability-based target measures. To preserve the order of original feature values after transformation, the hash functions applied by each client must be strictly monotonic. A monotonic transformation ensures that if an original feature value a is greater than b, the transformed value H(a) remains greater than H(b), preserving the rank order. Hash functions such as Randomized Rank-Preserving Mapping (RRPM), sigmoid functions, and logarithmic transformations can be employed to maintain monotonicity, ensuring that the relative structure of the data remains intact while rendering the feature values unintelligible to the modeler. As the hash functions are client-specific and operate independently across features, the transformed values do not reveal underlying patterns or relationships in the original data. In this way, FIG. 3 illustrates how transformation process 300 supports privacy preservation through feature-level obfuscation prior to any collaborative model training or inference.

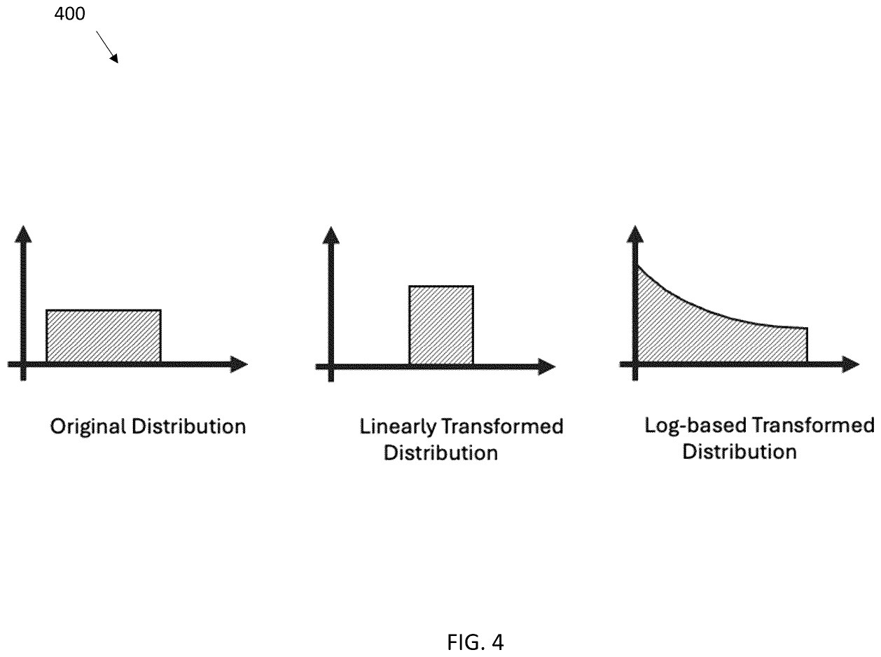

FIG. 4 is a diagram illustrating an example 400 of how different transformation functions applied to the same original feature distribution may result in diverging value distributions across clients, in accordance with one or more embodiments of the current subject matter. As shown in FIG. 4, the leftmost chart represents an original distribution of a summarized feature before any transformation is applied. In some embodiments, the original distribution may be approximately uniform or symmetric, depending on the feature. For example, the original distribution may correspond to a physiological measure such as average heart rate or blood pressure variability, computed across a population of patients.

The middle chart in FIG. 4 depicts a linearly transformed distribution of the same feature, as might be generated by one client using a client-defined linear mapping function. In this case, although the numeric values have been shifted or scaled, the shape of the distribution remains relatively consistent with the original.

The rightmost chart in FIG. 4 shows a log-based transformed distribution of the same underlying feature, produced by another client using a different, non-linear hash function. In some embodiments, such log-based transformations may be used to compress high-value ranges or skew the distribution in a non-symmetric manner. As depicted, the resulting distribution becomes more right-skewed, with a concentration of values near the lower end and a long tail extending to the right.

These examples highlight that client-defined hash functions, even if monotonic, may produce transformed values that follow significantly different statistical distributions. Because the modeler does not have access to the original transformation functions or value mappings, direct comparison or alignment of these hashed values across clients may not be feasible. Accordingly, FIG. 4 illustrates why the approach described herein relies on learning target-related measures from each client's own transformed value space, rather than directly using the transformed values themselves as model inputs.

In some embodiments, the transformed dataset received from each client includes hashed features that are individually unintelligible and statistically non-alignable across clients/data owners. To support collaborative training, the modeler may construct client- and feature-specific estimators of target-related measures, referred to herein as Probability of Target Measures (PTMs). A PTM represents a numerical score that reflects the statistical association between a transformed value of a feature and the likelihood of a target event, such as the onset of sepsis. These estimators may be derived by analyzing the distribution of hashed feature values and their co-occurrence with known target labels within each client's dataset.

For example, certain clinical features-such as heart rate variability or lactate levels—may be more strongly associated with sepsis onset, while others-such as recent administrative entries—may exhibit weaker correlation. The association may also vary depending on the value range. For instance, a transformed feature value corresponding to an abnormally high heart rate may indicate higher sepsis risk, even if the original value is not available to the modeler. Because hashed values are not directly interpretable, the modeler may instead rely on historical label co-occurrence within transformed intervals to estimate these probabilities.

In some embodiments, a PTM may be expressed using Weight of Evidence (WOE), which quantifies the relationship between a hashed feature value and the target label using the relative proportions of positive and negative outcomes. Other estimation methods may also be used. Once calculated, PTM values provide a common statistical representation across clients, enabling the pooling of PTM-based input vectors for training a neural network.

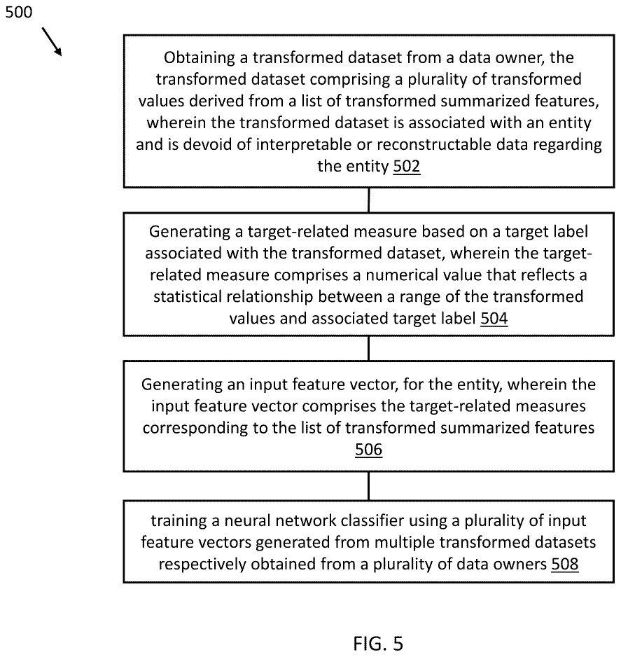

FIG. 5 is a diagram illustrating a flow chart of a process 500 for training a neural network classifier using privacy-preserving, client-transformed data, in accordance with one or more embodiments of the current subject matter. As shown in FIG. 5, the process 500 may begin with operation 502, wherein the system may obtain a transformed dataset from a data owner. The transformed dataset may comprise a plurality of transformed values derived from a list of transformed summarized features. Each transformed dataset may be associated with an entity, such as a patient, and may be devoid of interpretable or reconstructable data regarding the entity.

In some embodiments, the transformed dataset may be generated entirely within the systems controlled by the data owner. The process may include extracting a plurality of summarized features from raw data, calculating values associated with the summarized features, and applying a client-defined transformation. For example, the summarized features may include statistical descriptors such as average heart rate, recent systolic pressure range, or temperature variability. The calculated values may then be mapped using a hash function that is monotonically increasing and private to the data owner. Such a function may preserve the order of input values while rendering the transformed values unintelligible to external systems.

The transformation may be represented as a function Hi(v), where Hi(v) is a monotonic transformation applied to the i-th summarized feature value v. The output values, referred to herein as hashed features, may be unique to the data owner and structurally incompatible with those from other data owners. As a result, the transformed dataset may provide sufficient structure for downstream statistical operations without exposing the original feature values or allowing reconstruction.

In some embodiments, alternative transformation mechanisms may be used, such as nonlinear mappings, log-based compression functions, or randomized encoding schemes, provided they maintain value ordering and structural consistency within a client's data. The transformed dataset obtained in operation 502 forms the privacy-preserving basis for subsequent computation of target-related measures. Once PTM estimators are generated for each hashed feature, the system constructs input feature vectors by combining these PTMs for each entity. These vectors, derived from multiple clients, are then aggregated and used to train a neural network model. The training process minimizes a supervised loss function, such as binary cross-entropy, to optimize the model's ability to predict target outcomes. By aggregating PTM-based input vectors from multiple clients, the system ensures that the trained model benefits from diverse and representative data while maintaining strict data privacy.

Next, in operation 504, the system may generate a target-related measure based on a target label associated with the transformed dataset. The target-related measure may comprise a numerical value that reflects a statistical relationship between a range of the transformed values and the associated target label. In one embodiment, to convert continuous hashed feature values into target-related measures, the system applies a binning process that divides the transformed values into discrete intervals. Different binning strategies can be employed, such as equal-width binning, where the range of values is divided into intervals of equal size, or equal-frequency binning, where each interval contains approximately the same number of data points. Alternatively, domain-specific binning schemes can be applied to partition feature values based on domain knowledge or data characteristics, ensuring that the resulting target-related measures accurately capture the relationship between the hashed feature values and the target label. In some embodiments, the system may process each transformed summarized feature independently by analyzing its value distribution and its co-occurrence with target labels, such as whether or not a patient developed sepsis during an observed period.

In some embodiments, to support this process, the system may first convert the plurality of transformed values into a plurality of discrete intervals. The conversion may be performed using a client-specific converting scheme selected based on the statistical characteristics of the transformed values. For example, the converting scheme may define intervals using equal-width binning, equal-frequency binning, or domain-informed breakpoints, depending on the shape of the value distribution. Each interval may correspond to a contiguous range of transformed values.

Once the intervals are defined, the system may compute a target-related measure for each interval. In some embodiments, this computation may include calculating a frequency-based statistic representing the co-occurrence of target labels within each interval. For instance, the system may compute the proportion of examples within an interval that are labeled positive versus those labeled negative, indicating the local correlation strength between feature values and the outcome.

In some embodiments, the target-related measure may include a Weight of Evidence (WOE) score, calculated for each interval based on the relative proportions of positive and negative examples. Mathematically, for a given interval i, the WOE score may be computed as:

$${WOE}_{feature \_ i} = ln ( \frac{{P ( Positive )}_{i}}{{P ( Negative )}_{i}} )$$

wherein P(Positive); and P(Negative)ᵢ represent the proportions of positive and negative labels, respectively, within the i-th interval. For example, they may follow the following representations:

$${P ( Positive )}_{i} = \frac{Positive Cases in Category i}{Total Positive Cases}$$

$${P ( Negative )}_{i} = \frac{Negative Cases in Category i}{Total Negative Cases}$$

The result captures how predictive a given value range is for the occurrence of the target condition, such as sepsis or fraud detection.

In some embodiments, the system may further normalize these WOE values into probability-like scores, referred to as PTMs (Probability of Target Measures), to enhance model interpretability and ensure compatibility across clients. For example, a normalized PTM for interval i may be calculated as:

$$P T {M}_{i} = \frac{{WOE}_{i}}{{\sum }_{i} {P ( Positive )}_{i} \times {WOE}_{i}}$$

Different clients may define their own interval boundaries and compute their PTMs independently using only their local data. As a result, the same transformed feature may correspond to different interval schemes and PTM values across clients. However, each client-specific PTM mapping reflects a consistent statistical relationship between transformed value regions and the target, making them suitable for downstream aggregation in the consortium model.

Alternative implementations may use other types of target-related measures, such as mutual information scores, log-odds ratios, or empirically derived probabilities. The system may support flexible plug-in estimators depending on client data characteristics or modeling objectives.

A low WOE value (e.g., close to zero) may indicate that the corresponding interval has little or no correlation with the target outcome, whereas a high WOE value—whether positive or negative—may indicate strong association with the occurrence or absence of the target, depending on the sign. Through these calculations, hashed and otherwise non-interpretable values may be converted into PTM estimates that reflect the likelihood of the target condition, such as sepsis, associated with each transformed feature interval.

Next, in operation 506, the system may generate an input feature vector for the entity, wherein the input feature vector comprises the target-related measures corresponding to the list of transformed summarized features. Each position in the feature vector may correspond to a specific summarized feature, and the associated value may represent the estimated likelihood of the target event for the given entity, as determined by the transformed value falling within a particular interval of that feature's PTM mapping.

In some embodiments, each target-related measure may be selected by locating the interval in which the entity's hashed feature value resides and retrieving the corresponding PTM estimate for that interval. For example, if a patient's hashed temperature feature falls into an interval previously mapped to a high WOE score (indicating elevated sepsis risk), the PTM value for that interval may be used as the temperature component in the input feature vector.

The resulting input vector may be structured such that its dimensionality matches the number of transformed summarized features included in the dataset. Each element may be computed independently, and no original or hashed value needs to be included or stored within the vector itself. In some embodiments, client-specific feature ordering or feature naming conventions may be standardized at training time to enable consistent model input formatting across clients.

Alternative representations of the input vector may be supported, including sparse encodings, weighted vectors, or embeddings generated via downstream processing. However, the core requirement is that each input feature value be derived from a PTM estimate associated with a specific summarized feature for a given entity. This representation abstracts away the raw or hashed data while preserving statistical signals relevant to the prediction task.

Next, in operation 508, the system may train a neural network classifier using a plurality of input feature vectors generated from multiple transformed datasets respectively obtained from a plurality of data owners. Each input feature vector may be derived from a respective transformed dataset and may encode a privacy-preserving representation of target-related measures generated by applying client-specific PTM mappings to hashed feature values.

In some embodiments, training may involve assembling a combined training dataset from input feature vectors contributed by multiple data owners. The combined dataset may include a diverse range of target-related measures derived from different client-defined transformations, interval mappings, and hash functions. This diversity is normalized through the use of the client-specific target-related measures which then the neural network may be trained preserving alignment between target-related measures and predicted outcomes. In some embodiments, training may involve minimizing a supervised loss function that compares the predicted outcome with the ground truth label associated with each input feature vector. For example, a binary cross-entropy loss function may be used when the task involves predicting the likelihood of a binary event such as sepsis onset. Alternative training approaches may include multi-task learning, ensemble techniques, or federated learning models where model updates are computed locally and aggregated globally to improve prediction accuracy across clients. Depending on the nature of the input feature vectors and the characteristics of the target-related measures, the neural network architecture may be selected to optimize performance while maintaining privacy constraints.

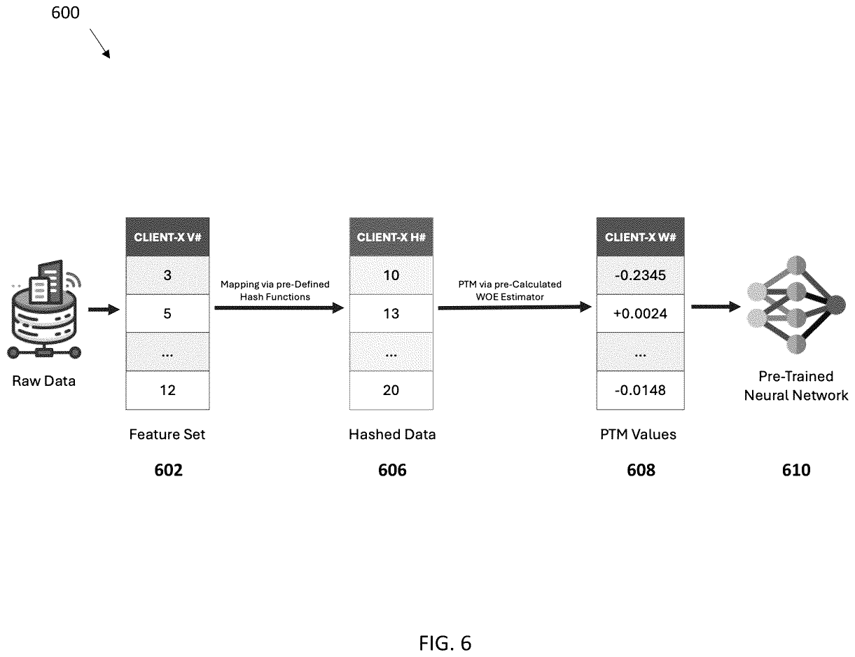

FIG. 6 illustrates an example system 600 for performing privacy-preserving inference using transformed datasets from a client, where the system processes hashed feature values to generate target-related measures that are subsequently provided to a pre-trained neural network. The system 600 is configured to operate in a distributed environment where client-side transformations protect sensitive data before submission to the modeler.

As shown in FIG. 6, system 600 includes multiple interconnected modules, beginning with a feature processing module 602, which generates a feature set from raw data associated with an entity, such as a patient being evaluated for sepsis risk. The feature set may include summarized values such as average heart rate, blood pressure trends, and body temperature fluctuations over a predefined observation period. These feature values, denoted as CLIENT-X V #, are numerical representations derived from raw data and serve as the basis for subsequent transformations.

The hashing module 606 is responsible for applying one or more client-defined, privacy-preserving hash functions to the feature set. These hash functions, which may be monotonically increasing and the same as applied to the training data, map each summarized feature value to a hashed value that is unintelligible and non-reconstructable. The hashed values, denoted as CLIENT-X H #, retain value ordering but obscure the original feature values. The hashing module 606 operates independently for each client, ensuring that the resulting transformed values remain private and consistent with the data owner's privacy requirements.

A PTM estimation module 608 processes the hashed data by applying a pre-calculated WOE (Weight of Evidence) estimator or other client-specific statistical mapping. This module converts hashed feature values into corresponding Probability of Target Measures (PTMs), denoted as CLIENT-X W #. These PTM values serve as statistically derived likelihood estimates indicating the association between the hashed feature value and the target event. For example, a hashed heart rate value falling into a specific interval may be mapped to a PTM reflecting the probability of sepsis onset.

Finally, the system 600 provides the PTM-based input feature vector to a pre-trained neural network 610 that generates an inference output. The neural network 610 may be optimized during training using PTM-based vectors obtained from multiple data owners, enabling collaborative model training while maintaining data privacy. During inference, the neural network processes the input feature vector and generates an output that represents the predicted likelihood of the target condition, such as the probability of sepsis.

In some embodiments, system 600 may include alternative PTM estimation techniques or support different neural network architectures, depending on the nature of the summarized features and the target prediction task. The modular structure of system 600 allows for extensibility and adaptation to diverse client configurations and privacy constraints

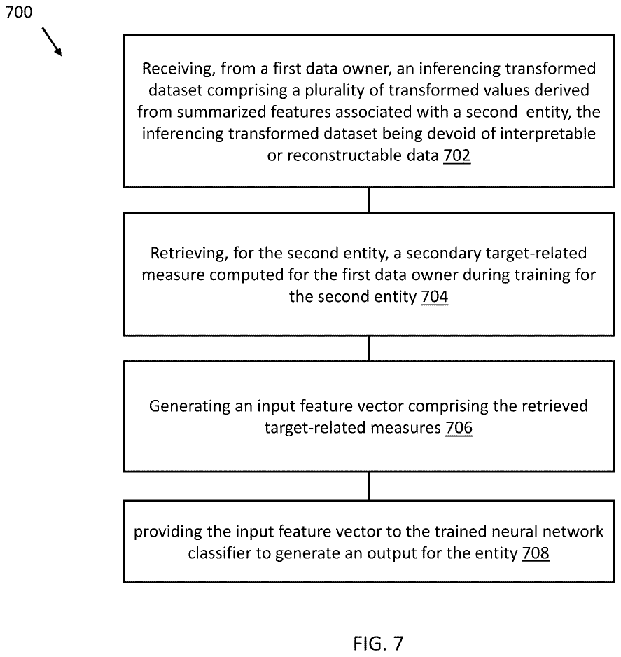

FIG. 7 is a diagram illustrating an example process 700 for performing inference on new, transformed datasets obtained from a data owner, where the transformed dataset contains hashed feature values derived from summarized features associated with an entity. As shown in FIG. 7, the process 700 may begin with operation 702, wherein the system may receive an inferencing transformed dataset from a first data owner. The inferencing transformed dataset may comprise a plurality of hashed values derived from summarized features associated with a second entity, such as a patient undergoing sepsis risk assessment. These hashed values, which are generated using a client-defined hash function, are devoid of interpretable or reconstructable information regarding the entity.

In operation 704, the system may retrieve a secondary target-related measure that was previously computed for the first data owner during training. The retrieved target-related measure corresponds to the hashed feature values associated with the second entity and is derived from the same client-defined hashing and interval mapping scheme that was used during training. To ensure consistent and accurate inference, the same hashing functions and binning schemes applied during model training must be used during inference. Since each client defines its own unique hashing and binning processes, any deviation during inference could introduce inconsistencies in PTM estimation and ultimately compromise prediction accuracy. The use of the original data owner's PTM mapping during inference is necessary to maintain consistency between training and inference. Since each data owner defines their own hashing scheme and binning intervals, the hashed feature values provided by the same data owner during inference must be mapped using the same statistical relationships learned during training.

More specifically, because the hashed values generated by the first data owner follow a unique and client-specific transformation, applying an alternative mapping scheme or using PTMs from another data owner would introduce inconsistencies. This is because the hashed intervals and the corresponding target-related measures (such as WOE or PTM) are learned based on the statistical distribution of the original feature values specific to that data owner. Using the same mapping ensures that the inferred PTMs accurately reflect the relationship between the hashed feature values and target events, preventing statistical drift or mismatch in the inference phase.

In operation 706, the system may generate an input feature vector for inference by incorporating the retrieved target-related measures associated with the hashed feature values of the second entity. Each value in the feature vector corresponds to a target-related measure, which has been mapped to the interval of the hashed feature values. The input feature vector serves as a structured, privacy-preserving representation of the entity's summarized features, with each value reflecting the statistical likelihood of the target event based on the pre-defined interval mappings.

Finally, in operation 708, the system may provide the input feature vector to the trained neural network classifier to generate an inference output for the entity. The output may represent a probability score, classification label, or other prediction reflecting the likelihood of the target event, such as the onset of sepsis. Since the input feature vector consists of hashed and statistically mapped values, the inference process maintains privacy by preventing the exposure of sensitive or interpretable feature values.

In some embodiments, alternative implementations may involve using different interval mapping techniques, other target-related estimators such as Bayesian probabilities or mutual information scores, or supporting federated inference protocols that allow model evaluation to occur without transmitting raw feature values.

### Performance Evaluation

To assess the effectiveness of the approach described herein and evaluate prediction performance, we conducted two sets of comparative analyses. The first analysis examined the performance of a neural network when applied to data from a single client. In this scenario, referred to as the “Single-Client Model,” the client utilized a single hash function to transform original feature values into hashed values, and the corresponding PTM mapping followed a Weight of Evidence (WOE) variable creation process applied across the entire training dataset.

In the second analysis, the same dataset was partitioned across two different clients, each defining its own hash function and applying separate WOE variable creation processes. The resulting neural network, trained on PTMs derived from this multi-client setup, is referred to as the “Two-Client Model.” For comparison, we also evaluated the performance of a model trained directly on the original data, referred to as the “Original Model.” By comparing the results of the Single-Client and Two-Client Models with the Original Model, we assessed how effectively the proposed privacy-preserving transformations maintained predictive accuracy while preventing data leakage.

The evaluation was conducted using a synthetic dataset designed to simulate a prediction task. The dataset contained time-series records of relevant measurements, with each record corresponding to a monitored individual. The dataset was split into training and test sets with approximately 70% of the data allocated for training and 30% for testing. The training set included 953,235 records, while the test set contained 505,267 records.

Prior to applying the hashing and PTM processes, 26 features were engineered based on relevant indicators. The objective was to train a neural network classifier to make accurate predictions within a specified observation window.

To evaluate model performance, the Receiver Operating Characteristic (ROC) curve is utilized to assess how well the model distinguished between positive and negative outcomes while minimizing false positives. Additionally, the Left Area Under the Curve (LAUC) metric was applied to quantify model performance within a 0-5% False Positive Rate (FPR) range, providing a numerical measure of the model's ability to accurately capture events while limiting false alarms.

To maintain consistency and facilitate a fair comparison, all models used a neural network architecture with a single hidden layer. However, because the Original, Single-Client, and Two-Client Models received different datasets as inputs—each subject to distinct hashing and WOE creation processes-model parameters were fine-tuned separately to optimize performance.

The Single-Client and Two-Client Models shared the same network architecture and hyperparameters, with the exception that the Two-Client Model used different hash functions and corresponding WOE creation processes for each client. Both models applied the continuous piecewise binning method. This method maintains the monotonic relationship between transformed feature values and the target event, allowing PTM estimates to effectively reflect probabilities derived from the original data.

The Single-Client Model applied a Ranked Ratio Preserving Mapping (RRPM) as the hash function, while the Two-Client Model utilized different transformation functions namely, a sigmoid function and a logarithmic transformation (modified to accommodate negative inputs) for each respective client. These transformations preserved order consistency across hashed values while enabling subsequent interval mapping and PTM computation.

TABLE 1
Neural Network learning parameters for the Original,
Single-and Two-Client Models

| | # of | | | |
|---|---|---|---|---|
| | Hidden | Learning | Dropout | Maximum |
| | Units | Rate | Rate | Epochs |
| Original | 10 | 0.0005 | 0.1 | 500 |
| Single-Client | 12 | 0.001 | 0.2 | 600 |
| Two-Client | 12 | 0.001 | 0.2 | 600 |

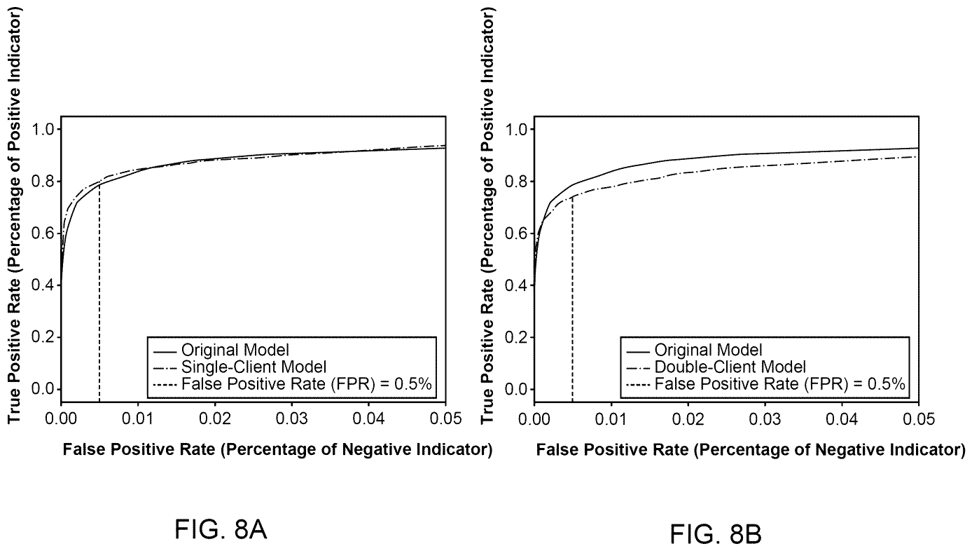

FIG. 8A illustrates the ROC curve comparison between the Original Model and the Single-Client Model, where the x-axis represents the False Positive Rate (FPR), and the y-axis represents the True Positive Rate (TPR) on a percentage basis.

The Original Model curve is trained directly on original data without applying privacy-preserving transformations. The Single-Client Model curve applies a single client-defined hash function to the feature set and uses a WOE-based PTM mapping for generating target-related measures. As shown in FIG. 8A, the dashed vertical line marks the False Positive Rate (FPR) threshold at 0.5%, which is a selected benchmark for evaluating model sensitivity within a low-FPR range. The curves demonstrate that the Single-Client Model maintains predictive accuracy comparable to the Original Model, with only a slight difference in performance at low FPR thresholds.

FIG. 8B illustrates the ROC curve comparison between the Original Model and the Two-Client Model. As shown in FIG. 8B, the x-axis represents the False Positive Rate (FPR) and the y-axis represents the True Positive Rate (TPR) for detection. The Original Model curve is trained directly on original data without applying privacy-preserving transformations. The Two-Client Model curve aggregates hashed feature values and PTM estimates from two different clients, each applying a unique hash function and binning process. As shown in FIG. 8B, the dashed vertical line marks the False Positive Rate (FPR) threshold at 0.5%, which is a selected benchmark for evaluating model sensitivity within a low-FPR range. The ROC curves in FIG. 8B demonstrate that the Two-Client Model maintains a high level of predictive performance, despite the increased complexity associated with managing multiple client-specific hash functions and PTM mappings. In some embodiments, additional model configurations may be used to further refine performance, including alternative PTM estimation techniques, different neural network architectures, or hybrid inference schemes that adapt to varying client data characteristics.

TABLE 1
Performance comparison of the Original, Single-and
Two-Client Models using fraud capture rate and LAUC
to assess their effectiveness in anomaly detection.

| | | Fraud | | |
|---|---|---|---|---|
| | | Capture | | |
| | | Rate at | | Number |
| | LAUC | 0.5% FPR | AUC | of Epochs |
| Original | 0.043387 | 0.784820 | 0.983322 | 200 |
| Single-Client | 0.043310 | 0.799625 | 0.981661 | 359 |
| Two-Client | 0.040861 | 0.736423 | 0.972871 | 314 |

As shown in table 2, the Two-Client Model, also referred to as the Consortium Model, demonstrated a slight reduction in performance compared to the Single-Client and Original Models. This model achieved a lower LAUC (0.040861) and Capture Rate (0.736423) at 0.5% FPR, with an overall AUC of 0.972871. The marginal decline in performance can be attributed to the fact that the Two-Client Model utilized two independent WOE creation processes for the two clients, each operating on only half the size of the dataset available to the Single-Client Model. When the data is divided between two clients, the volume of data available to estimate WOE and PTMs for each client is reduced by half, potentially leading to less precise interval mappings and target-related measure estimations due to half of data available for statistical analysis. This reduction in data volume can introduce slight discrepancies in PTM estimations, resulting in a minor performance drop. However, as the data volume increases and approaches the size of the single-client dataset, WOE estimation becomes more accurate, ultimately restoring predictive performance to a level comparable with the Single-Client Model. Since the WOE estimation is performed separately for each client, the reduced data volume may lead to less precise interval mappings and a corresponding decrease in target-related measure accuracy.

However, this slight reduction in performance is expected to diminish with larger data volumes. As the amount of data available to each client increases to a level comparable to the Single-Client setup, the accuracy of WOE estimation is likely to improve, resulting in predictive performance that approaches that of the Single-Client Model.

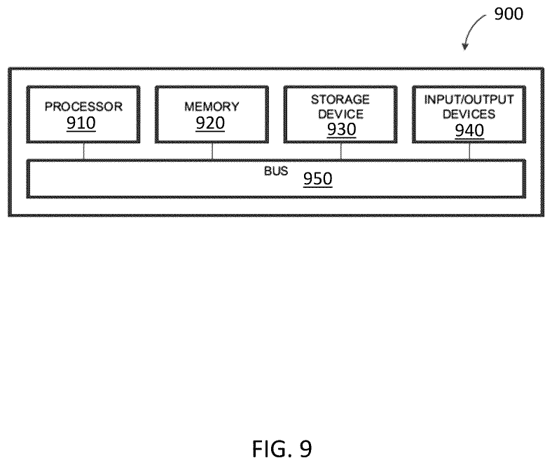

FIG. 9 depicts a block diagram illustrating a computing system 900 consistent with implementations of the current subject matter. As shown in FIG. 9, the computing system 900 can include a processor 910, a memory 920, a storage device 930, and input/output devices 940. The processor 910, the memory 920, the storage device 930, and the input/output devices 940 can be interconnected via a system bus 950. The computing system 900 may additionally or alternatively include a graphic processing unit (GPU), such as for image processing, and/or an associated memory for the GPU. The GPU and/or the associated memory for the GPU may be interconnected via the system bus 950 with the processor 910, the memory 920, the storage device 930, and the input/output devices 940. The memory associated with the GPU may store one or more images described herein, and the GPU may process one or more of the images described herein. The GPU may be coupled to and/or form a part of the processor 910. The processor 910 is capable of processing instructions for execution within the computing system 900. In some implementations of the current subject matter, the processor 910 can be a single-threaded processor. Alternately, the processor 910 can be a multi-threaded processor. The processor 910 is capable of processing instructions stored in the memory 920 and/or on the storage device 930 to display graphical information for a user interface provided via the input/output device 940.

The memory 920 is a computer-readable medium, such as volatile or non-volatile memory, that stores information within the computing system 900. The memory 920 can store data structures representing configuration object databases, for example. The storage device 930 is capable of providing persistent storage for the computing system 900. The storage device 930 can be a floppy disk device, a hard disk device, an optical disk device, or a tape device, or other suitable persistent storage means. The input/output device 940 provides input/output operations for the computing system 900. In some implementations of the current subject matter, the input/output device 940 includes a keyboard and/or pointing device. In various implementations, the input/output device 940 includes a display unit for displaying graphical user interfaces.

According to some implementations of the current subject matter, the input/output device 940 can provide input/output operations for a network device. For example, the input/output device 940 can include Ethernet ports or other networking ports to communicate with one or more wired and/or wireless networks (e.g., a local area network (LAN), a wide area network (WAN), the Internet).

In some implementations of the current subject matter, the computing system 900 can be used to execute various interactive computer software applications that can be used for organization, analysis and/or storage of data in various (e.g., tabular) format (e.g., Microsoft Excel®, and/or any other type of software). Alternatively, the computing system 900 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 940. The user interface can be generated and presented to a user by the computing system 900 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

### Use Case 1

In one use case, the system can be applied to supply chain management scenarios where multiple clients, including suppliers, manufacturers, and logistics providers, collaborate to predict and mitigate potential supply chain disruptions while maintaining strict data privacy. In a typical supply chain scenario, various entities generate sensitive operational data, such as delivery timelines, supplier reliability metrics, inventory levels, and shipment delays. However, sharing raw operational data among these entities may expose proprietary information and violate regulatory compliance standards. To address these concerns, the system described herein enables the development of a collaborative, privacy-preserving consortium model to predict supply chain risks without revealing sensitive information.

In some embodiments, each participating entity (e.g., Supplier A, Supplier B, and Logistics Partner C) applies client-defined, privacy-preserving hash functions to transform raw operational data into hashed feature values. These hashed values, devoid of interpretable or reconstructable information, are then mapped to Probability of Target Measures (PTMs) through Weight of Evidence (WOE) or similar transformation processes. PTMs estimate the likelihood of supply chain disruptions, such as delays in shipment, inventory shortages, or supplier failures, based on the hashed feature values. For example, Supplier A may hash data on production capacity and defect rates, Supplier B may hash data on order fulfillment speed and backlog trends, while Logistics Partner C hashes data on transportation delays and route congestion. These hashed values are then mapped to PTM values that reflect the likelihood of potential risks occurring under various operational conditions.

To further enhance the predictive accuracy, the hashed feature values are binned into discrete intervals, with PTM values being estimated for each interval. These PTM values are subsequently assembled into an input feature vector that represents the estimated target-related measures across different operational conditions. The input feature vector is then provided to a neural network classifier trained to identify potential supply chain risks. During the training phase, the neural network learns patterns from PTM values derived from multiple participating clients and improves its ability to detect high-risk scenarios in future predictions.

In some embodiments, the system predicts the likelihood of shipment delays by analyzing hashed operational data from suppliers and logistics partners. For instance, if the hashed value for a supplier's delivery time variability falls within a particular interval, the corresponding PTM value may indicate an elevated risk of shipment delay. Similarly, if hashed data from a logistics partner suggests potential route congestion, the system may update the PTM value to reflect a higher likelihood of delayed delivery. The neural network aggregates these PTM values to generate an overall risk prediction and alerts relevant stakeholders when a high probability of supply chain disruption is detected.

The collaborative nature of the consortium model allows the neural network to benefit from a richer and more diverse dataset, improving the generalizability of predictions across different supply chain scenarios. Despite the use of privacy-preserving transformations, the model maintains high predictive accuracy by leveraging PTM estimates that capture statistical relationships between hashed feature values and target outcomes. Moreover, the system is inherently scalable, enabling the inclusion of additional clients to contribute hashed feature values and PTM estimates, thereby enhancing the model's predictive robustness over time.

From a privacy perspective, the system described herein maintains strict control over sensitive client data by ensuring that only derived PTM values, devoid of original feature information, are transmitted to the modeler. Since PTM mappings are independently computed by each client and only shared with the modeler in a non-interpretable format, the confidentiality of operational data is preserved throughout the model training and inference processes. As the volume of data contributed by each client increases, the precision of WOE-based PTM estimation is further enhanced, which can reduce potential performance gaps between consortium models and models trained on original data.

In some embodiments, the consortium model's ability to predict supply chain disruptions can be further improved by fine-tuning model parameters based on different operational contexts. For instance, adjustments to the binning scheme or modification of the neural network architecture may enhance the model's ability to adapt to evolving supply chain dynamics. As more data becomes available, the consortium model continues to refine its predictions, providing supply chain stakeholders with a robust and privacy-preserving risk management solution.

In summary, the system described herein offers a powerful solution for predicting supply chain risks by leveraging privacy-preserving transformations and collaborative modeling. Through the use of hashed feature values, PTM estimation, and neural network training, the system allows multiple supply chain participants to contribute operational data without compromising data privacy. This approach not only enhances the predictive accuracy of risk detection models but also supports scalable and secure collaboration across diverse supply chain ecosystems.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method, comprising:
obtaining a transformed dataset from a data owner, the transformed dataset comprising a plurality of transformed values derived from a list of transformed summarized features, wherein the transformed dataset is associated with an entity and is devoid of interpretable or reconstructable data regarding the entity;
generating a target-related measure based on a target label associated with the transformed dataset, wherein the target-related measure comprises a numerical value that reflects a statistical relationship between a range of the transformed values and associated target label;
generating an input feature vector, for the entity, wherein the input feature vector comprises the target-related measures corresponding to the list of transformed summarized features; and
training a neural network classifier using a plurality of input feature vectors generated from multiple transformed datasets respectively obtained from a plurality of data owners, wherein the plurality of input feature vectors comprises the input feature vector.

2. The method of claim 1, wherein the transformed dataset is generated by:
extracting a plurality of summarized features from a raw dataset using methods that are transparent to the data owners and executed within systems controlled by the data owners;
calculating values associated with the plurality of summarized features; and
hashing the values of the plurality of summarized features using a monotonically increasing hash function that preserves order of the values to generate the plurality of transformed values for the transformed dataset, wherein the hash function is data owner-defined and private to the data owner.

3. The method of claim 1, further comprising:
converting the plurality of transformed values into a plurality of intervals based on a statistical distribution of the transformed values by applying a converting scheme to the transformed values, wherein the converting scheme is data owner-specific, wherein each of the plurality of intervals corresponds to a range of the transformed values in the plurality of the transformed values.

4. The method of claim 1, wherein generating the target-related measure comprises computing, for each interval, a frequency-based statistic representing co-occurrence of target labels within the interval.

5. The method of claim 1, wherein the target-related measure comprises a weight of evidence value calculated for each interval based on relative proportions of positive and negative target labels.

6. The method of claim 1, wherein the input feature vector comprises a plurality of target-related measures corresponding to different summarized features within the transformed dataset.

7. The method of claim 1, further comprising:
receiving, from a first data owner, an inferencing transformed dataset comprising a plurality of transformed values derived from summarized features associated with a second entity, the inferencing transformed dataset being devoid of interpretable or reconstructable data;
retrieving, for the second entity, a secondary target-related measure computed for the first data owner during training for the second entity;
generating an input feature vector comprising the retrieved target-related measures; and
providing the input feature vector to the trained neural network classifier to generate an output for the entity.

8. A system comprising:
at least one programmable processor; and
a non-transient machine-readable medium storing instructions that, when executed by the processor, cause the at least one programmable processor to perform operations comprising:
obtaining a transformed dataset from a data owner, the transformed dataset comprising a plurality of transformed values derived from a list of transformed summarized features, wherein the transformed dataset is associated with an entity and is devoid of interpretable or reconstructable data regarding the entity;
generating a target-related measure based on a target label associated with the transformed dataset, wherein the target-related measure comprises a numerical value that reflects a statistical relationship between a range of the transformed values and associated target label;
generating an input feature vector, for the entity, wherein the input feature vector comprises the target-related measures corresponding to the list of transformed summarized features; and
training a neural network classifier using a plurality of input feature vectors generated from multiple transformed datasets respectively obtained from a plurality of data owners, wherein the plurality of input feature vectors comprises the input feature vector.

9. The system of claim 8, wherein the transformed dataset is generated by:
extracting a plurality of summarized features from a raw dataset using methods that are transparent to the data owners and executed within systems controlled by the data owners;
calculating values associated with the plurality of summarized features; and
hashing the values of the plurality of summarized features using a monotonically increasing hash function that preserves order of the values to generate the plurality of transformed values for the transformed dataset, wherein the hash function is data owner-defined and private to the data owner.

10. The system of claim 8, wherein the operations further comprise:
converting the plurality of transformed values into a plurality of intervals based on a statistical distribution of the transformed values by applying a converting scheme to the transformed values, wherein the converting scheme is data owner-specific, wherein each of the plurality of intervals corresponds to a range of the transformed values in the plurality of the transformed values.

11. The system of claim 8, wherein the operation of generating the target-related measure comprises computing, for each interval, a frequency-based statistic representing co-occurrence of target labels within the interval.

12. The system of claim 8, wherein the target-related measure comprises a weight of evidence value calculated for each interval based on relative proportions of positive and negative target labels.

13. The system of claim 8, wherein the input feature vector comprises a plurality of target-related measures corresponding to different summarized features within the transformed dataset.

14. The system of claim 8, wherein the operations further comprise:
receiving, from a first data owner, an inferencing transformed dataset comprising a plurality of transformed values derived from summarized features associated with a second entity, the inferencing transformed dataset being devoid of interpretable or reconstructable data;
retrieving, for the second entity, a secondary target-related measure computed for the first data owner during training for the second entity;
generating an input feature vector comprising the retrieved target-related measures; and
providing the input feature vector to the trained neural network classifier to generate an output for the entity.

15. A computer program product comprising a non-transient machine-readable medium storing instructions that, when executed by at least one programmable processor, cause the at least one programmable processor to perform operations comprising:
obtaining a transformed dataset from a data owner, the transformed dataset comprising a plurality of transformed values derived from a list of transformed summarized features, wherein the transformed dataset is associated with an entity and is devoid of interpretable or reconstructable data regarding the entity;
generating a target-related measure based on a target label associated with the transformed dataset, wherein the target-related measure comprises a numerical value that reflects a statistical relationship between a range of the transformed values and associated target label;
generating an input feature vector, for the entity, wherein the input feature vector comprises the target-related measures corresponding to the list of transformed summarized features; and
training a neural network classifier using a plurality of input feature vectors generated from multiple transformed datasets respectively obtained from a plurality of data owners, wherein the plurality of input feature vectors comprises the input feature vector.

16. The computer program product of claim 15, wherein the transformed dataset is generated by:
extracting a plurality of summarized features from a raw dataset using methods that are transparent to the data owners and executed within systems controlled by the data owners;
calculating values associated with the plurality of summarized features; and
hashing the values of the plurality of summarized features using a monotonically increasing hash function that preserves order of the values to generate the plurality of transformed values for the transformed dataset, wherein the hash function is data owner-defined and private to the data owner.

17. The computer program product of claim 15, wherein the operations further comprise:
converting the plurality of transformed values into a plurality of intervals based on a statistical distribution of the transformed values by applying a converting scheme to the transformed values, wherein the converting scheme is data owner-specific, wherein each of the plurality of intervals corresponds to a range of the transformed values in the plurality of the transformed values.

18. The computer program product of claim 15, wherein the operation of generating the target-related measure comprises computing, for each interval, a frequency-based statistic representing co-occurrence of target labels within the interval.

19. The computer program product of claim 15, wherein the target-related measure comprises a weight of evidence value calculated for each interval based on relative proportions of positive and negative target labels.

20. The computer program product of claim 15, wherein the operations further comprise:
receiving, from a first data owner, an inferencing transformed dataset comprising a plurality of transformed values derived from summarized features associated with a second entity, the inferencing transformed dataset being devoid of interpretable or reconstructable data;
retrieving, for the second entity, a secondary target-related measure computed for the first data owner during training for the second entity;
generating an input feature vector comprising the retrieved target-related measures; and
providing the input feature vector to the trained neural network classifier to generate an output for the entity.
